(19) United States
(12) Patent Application Publication
(10) Pub. No.: US 2006/0032844 A1
(43) Pub. Date: Feb. 16, 2006

(54) Vehicle coolant heating system

(76) Inventor: William R. Kingrey, Maunee, OH (US)

Correspondence Address: BOWERS HARRISON LLP;GARY K. PRICE, ESP., 25 RIVERSIDE DRIVE, PO BOX 1287, EVANSVILLE, IN, 47706-1287, US

(21) Appl. No.: 10/918,243

(22) Filed: Aug. 13, 2004

(51) Int. Cl. B60L 1/02

(52) U.S. Cl. 219/208

(57) ABSTRACT

A vehicle coolant heating system that heats engine coolant that flows through the vehicle's heater core. The heating system includes a diverter in fluid communication with the vehicle's water pump that pumps engine coolant from the engine block. The diverter is in fluid communication with an in-line electric heater that heats the coolant to a desired temperature. An outlet hose is coupled to the in-line electric heater. The heated coolant flows through the outlet hose and is supplied to the vehicle's heater core. A pump is in fluid communication with the diverter and the in-line electric heater. The pump is operated by remote control means and activates the flowing of low temperature engine coolant to the diverter, prior to the starting of the vehicle's engine. The coolant flows through the diverter and through the pump, into the in-line electric heater that instantly heats the coolant to the desired temperature. The heated coolant is directed from the electric heater, through the outlet hose, and to the vehicle's heater core.

### CROSS REFERENCES TO RELATED APPLICATIONS

None.

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

The present invention relates generally to vehicle engine coolant, and more particular, to a system for heating and pre-heating a vehicle's engine coolant. The heated coolant then flows through the vehicle's heater core, heat is further transferred from the heater core to the vehicle's ductwork by passing through the vehicle's heater fan.

2. Brief Description of Prior Art

Attempts to solve the problems of cold engine start up and associated engine wear, and delayed provision of warm air to passenger compartment have been made. These attempts cover simple heaters as well as elaborate integrated systems.

For example, U.S. Pat. No. 3,853,270 discloses a storage tank disposed between the water pump and the passenger compartment heater. The tank is designed to store coolant heated by the engine during normal operation. The stored coolant is recirculated when the engine is restarted. This system, however, does not heat the coolant independently of the engine; therefore, the temperature in the coolant in the tank will decrease over time to the point where it is ambient temperature.

U.S. Pat. No. 3,969,605 discloses an in-line coolant pre-heater reservoir containing an electrical heater. The system is not designed to rapidly heat the passenger compartment or engine start-up, but rather keeps the coolant at an elevated temperature while the engine is not operating. When in operation, the device has to raise the pressure in the coolant line such that the temperature of the coolant reaches its boiling point.

U.S. Pat. No. 4,454,984 discloses and auxiliary electric pump in the coolant line that continues to circulate warm coolant through the passenger compartment heater after the automobile engine is shut down. The auxiliary pumping system will not operate when the engine is running, and therefore, the electric pump cannot heat the coolant upon engine start-up.

U.S. Pat. No. 5,407,130 discloses a heat storage devise in series with the engine coolant line. The storage device transfers heat that was stored from previous motor operation to engine coolant on engine start-up to heat the passenger compartment in the engine. This only permits storage of heated coolant, not the heating of the coolant.

U.S. Pat. No. 5,333,679 discloses an automobile climate control system which uses a hydraulic pump driven by the engine to produce a working oil under pressure and a hydraulic relief valve to convert the pressure energy of the oil into thermal energy. The thermal energy is then transferred to the engine coolant which is then circulated through a heat exchanger to heat the passenger compartment. The system does not rapidly heat the coolant on engines start-up.

As will be seen from the subsequent description, the preferred embodiments of the present invention overcome shortcomings of the prior art.

### SUMMARY OF THE INVENTION

The present invention relates to a vehicle engine coolant for heating and pre-heating a vehicle's engine coolant. The vehicle coolant heating system generally includes a supply hose providing fluid communication between a diverter valve and the prior art engine water pump that pumps engine coolant from the engine block. The diverter valve is coupled to a by-pass hose in fluid communication with an in-line electric heater that instantly heats the engine coolant to a desired temperature. An outlet hose is coupled to the in-line electric heater, the heated coolant flows from the electric heater through the outlet hose and is supplied to the vehicle's heater core. The vehicle's heater fan further transfers the heat from the coolant in the heater core to the vehicle's ductwork.

The vehicle coolant system further includes a pre-heater pump coupled on one end to an intake hose and on the opposite end to a return hose, the intake hose connected to the diverter valve, and the return hose having one end connected to the pre-heater pump and the opposite end joins the by-pass hose that is coupled to the in-line electric heater. The pre-heater pump is operated by remote control means known in the art and actuates the flowing of low temperature engine coolant from the supply hose between the diverter valve and the prior art engine water pump, prior to the starting of the vehicle's engine. The coolant flows through the diverter valve and through the return hose connected to the pre-heater pump, and into the in-line electric heater that instantly heats the coolant to a desired temperature. The heated coolant flows through the outlet hose and is supplied to the vehicle's heater core.

### BRIEF DESCRIPTION OF THE DRAWINGS

FIG. 1 is a diagram of a preferred embodiment of the present invention, a vehicle coolant heating system.

FIG. 2 is an exploded view of the components of the present invention of FIG. 1 namely, the heater valve, the pre-heater pump, and the in-line electric heater.

### DESCRIPTION OF THE PREFERRED EMBODIMENT

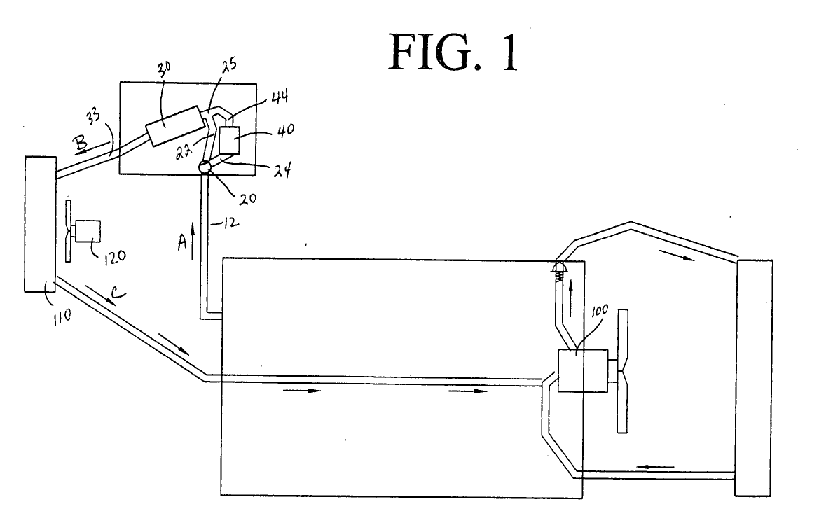

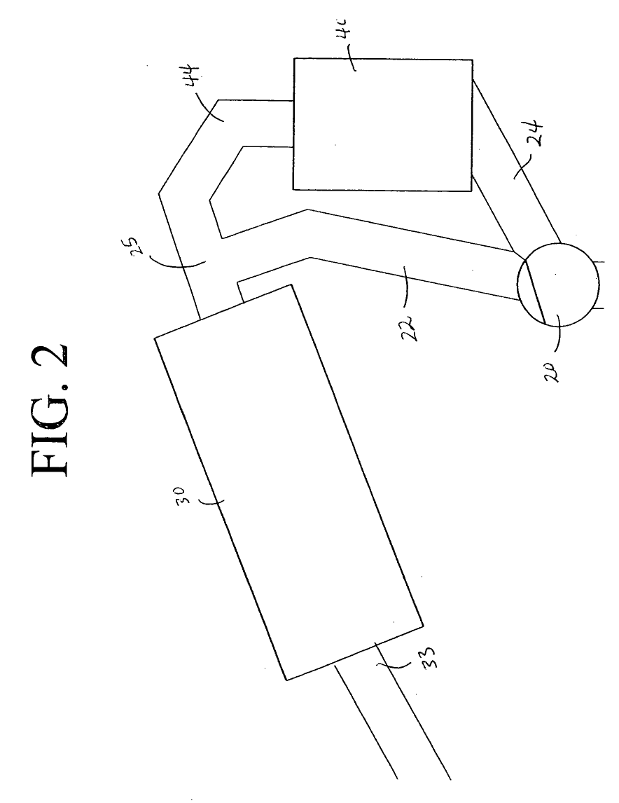

FIGS. 1-2 illustrate a preferred embodiment of a vehicle coolant heating system 10 made in accordance with the present invention. The vehicle coolant heating system 10 for heating and pre-heating a vehicle's engine coolant. The heated coolant then flows through the vehicle's heater core. A heater fan further transfers heat from the heated coolant to the vehicle's ductwork for pre-heating the passenger compartment of the vehicle.

Specifically, it will be noted in the drawings that the device relates to a vehicle coolant heating system for heating and pre-heating a vehicle's engine coolant and as a result, resolving the problems associated with cold engine start up, and heating and pre-heating the vehicle's passenger compartment. In the broadest context, the device consists of components configured and correlated with respect to each other so as to attain the desired objective.

Referring to FIGS. 1-2, the vehicle coolant heating system 10 includes a supply hose 12 providing fluid communication between a diverter valve 20 and a prior art engine water pump 100 that pumps heatable engine coolant (not shown) from a vehicle's engine block.

The diverter valve 20 as known in the art, having an inlet 20A and outlet pathways 20B, 20C. As will be described, the outlet pathway 20B selectively directs engine coolant to a by-pass hose 22, or the outlet pathway 20C selectively directs the coolant to a pre-heater pump 40.

The diverter valve 20 is coupled to the by-pass hose 22 in fluid communication with an in-line electric heater 30 that instantly heats the coolant to a desired temperature. An outlet hose 33 is coupled to the in-line electric heater 30. The heated coolant flows through the outlet hose 33 and is supplied to the vehicle's heater core 110. Further, the vehicle's heater fan 120 transfers the heat from the coolant in the heater core 110 to the vehicle's ductwork in order to heat the passenger compartment of the vehicle.

The pre-heater pump 40 is coupled to an end 24A of an intake hose 24, and to an end 44A of a return hose 44. The intake hose 24 having an opposite end 24B appropriately connected to the diverter valve 20, and the return hose 44 having an opposite end 44B joined to the by-pass hose 22 at joint 25, the joint 25 having an outlet 25A appropriately coupled to the in-line electric heater 30.

In the preferred embodiment, the pre-heater pump 40 is operated by remote control means (not shown) known in the art and activates the flowing of low temperature engine coolant from the supply hose 12 between the diverter valve 20 and the vehicle's engine block 120 prior to the starting of the vehicle's engine. The coolant flows through the diverter valve 20 and through the intake hose 24 connected to the pre-heater pump 40. The coolant then passes through the pump 40 and through the return hose 44 into the by-pass hose 22 at joint 25. The joint 25 is coupled to the in-line electric heater 30 that instantly heats the coolant to a desired temperature. The heated coolant flows from the electric heater 30, through the outlet hose 33 and is supplied to the vehicle's heater core 110. As previously described, the vehicle's heater fan 120 further transfers the heat from the coolant in the heater core 110 to the vehicle's ductwork.

The application of the vehicle coolant heating system 10 is as follows:

To Instantly Heat Engine Coolant:

Upon starting the vehicle's engine, the supply hose 12 provides heatable fluid to the diverter valve 20 from the engine water pump 100 that pumps engine coolant from the vehicle's engine block 120. The fluid flows to the diverter valve 20 in the direction designated as Arrow “A” in FIG. 1. The low temperature coolant flows through the outlet pathway 20B of the diverter valve 20, through the by-pass hose 22 at joint 25. The joint 25 is coupled to the in-line electric heater 30 that instantly heats the coolant to a desired temperature. The heated coolant flows from the electric heater 30, through the outlet hose 33 in the direction designated as Arrow “B”. The outlet hose 30 coupled to the electric heater 30 supplies the heated coolant to the vehicle's heater core 110. The vehicle's heater fan further transfers the heat from the coolant in the heater core 110 to the vehicle's ductwork in the direction designated Arrow “C”.

To Pre-Heat Engine Coolant:

Activating the pre-heater pump 40 by remote control means (not shown) as known in the art activates the flowing of low temperature engine coolant from the supply hose 12 between the diverter valve 20 and the vehicle's engine block 120 to the diverter valve 20 as designated Arrow “A” in FIG. 1. The pre-heater pump 40 is activated prior to the starting of the vehicle's engine. The low temperature engine coolant flows through the diverter valve 20 and through the intake hose 24 connected to the pre-heater pump 40. The coolant then passes through the pump 40 and through the return hose 44 into the joint 25. The joint 25 is coupled to the in-line electric heater 30 that instantly heats the coolant to a desired temperature. The heated coolant flows from the electric heater 30, through the outlet hose 33 as designated Arrow “B” and supplied to the vehicle's heater core 110. The vehicle's heater fan transfers the heat from the coolant in the heater core 110 to the vehicle's ductwork in the direction designated Arrow “C”.

Although the description above contains many specificities, these should not be construed as limiting the scope of the invention but as merely providing illustrations of some of the presently preferred embodiments of this invention.

Thus the scope of the invention should be determined by the appended claims in the. formal application and their legal equivalents, rather than by the examples given.

I claim:

1. A vehicle coolant heating system comprising:
a valve,
a pump,
an electric heater,
wherein the valve having an inlet in fluid communication with the vehicle's engine water pump, said water pump containing a heatable fluid, said valve further including an outlet in fluid communication with the electric heater,
wherein the pump having an outlet in fluid communication with the electric heater and an inlet in fluid communication with a vehicle's engine block,
wherein the electric heater is in fluid communication with said vehicle's heater core.

2. The vehicle coolant heating system as recited in claim 1, wherein a heater fan of the vehicle transfers heat from the heated coolant to the vehicle's ductwork.

3. The vehicle coolant heating system as recited in claim 1, wherein the electric heater is an in-line electric heater.

4. The vehicle coolant heating system as recited in claim 3, wherein the electric heater is electrically powered by an engine current.

5. The vehicle coolant heating system as recited in claim 1, wherein the pump is electrically powered by an engine current.

6. The vehicle coolant heating system as recited in claim 1, wherein the outlet having a first flow path in fluid communication with the electric heater and a second flow path in fluid communication with the pump.

7. The vehicle coolant heating system as recited in claim 1, wherein the pump is actuated through remote control means.

8. A vehicle coolant system comprising:
a diverter valve having an inlet, and first and second outlets, said inlet in fluid communication with a vehicle's heatable fluid, said first outlet of the diverter valve in fluid communication with an electric heater, said second outlet in fluid communication with a heater pump, said heater pump in fluid communication with said electric heater,
an outlet hose having a first end connected to the electric heater and a second end connected to a heater core of the vehicle, wherein the electric heater discharges a heated coolant through said outlet hose to said heater core.

9. The vehicle coolant heating system as recited in claim 8, wherein an electric fan of the vehicle transfers heat from the heated coolant to the vehicle's ductwork.

10. The vehicle coolant heating system as recited in claim 8, wherein the electric heater is an in-line electric heater.

11. The vehicle coolant heating system as recited in claim 10, wherein the electric heater is electrically powered by an engine current.

12. The vehicle coolant heating system as recited in claim 8, wherein the heater pump is electrically powered by an engine current.

13. The vehicle coolant heating system as recited in claim 8, wherein the heater pump is actuated through remote control means.

14. A method of heating a vehicle's low temperature engine coolant comprising the following steps in the sequence set forth:
passing the engine's low temperature coolant to a heater valve,
passing the engine coolant from the heater valve to an electric heater,
heating the engine coolant through the electric heater,
passing the engine coolant from the electric heater to the vehicle's heater core.

15. The method as recited in claim 14, wherein the step of passing the engine coolant to the electric heater includes directing the coolant from the heater valve to a pump, directing the coolant from the pump to the electric heater.

16. The method as recited in claim 15, wherein the step of passing the engine coolant to the heater valve includes providing a signal to actuate the pump.
